(19) United States
(12) Patent Application Publication
(10) Pub. No.: US 2018/0035770 A1
(43) Pub. Date: Feb. 8, 2018

(54) UMBRELLA EXTENSION FOR HUMAN AND PET

(71) Applicant: Kara LaBella, Raleigh, NC (US)

(72) Inventor: Kara LaBella, Raleigh, NC (US)

(73) Assignee: Kara LaBella, Raleigh, NC (US)

(21) Appl. No.: 15/231,147

(22) Filed: Aug. 8, 2016

(51) Int. Cl. A45B 25/18; A45B 25/02; A01K 29/00; A45B 19/04; A45B 25/16; A45B 11/00; A45B 25/14

(52) U.S. Cl. CPC A45B 25/18; A45B 11/00; A45B 25/02; A45B 25/14; A45B 19/04; A45B 25/16; A01K 29/00; A45B 2025/186; A45B 2200/1009

(57) ABSTRACT

An extended umbrella providing a secondary canopy coverage area for a pet. The secondary canopy coverage area is supported by a secondary structure attached to a main umbrella shaft with a clamp. Alternatively, the secondary canopy coverage area is provided with no secondary shaft attached to the main umbrella shaft, with the extended canopy connected to a main umbrella by interlocking the ribs with the extension canopy. The secondary coverage area alternatively is formed by an extended umbrella forming a canopy that is continuous and supported with two sections of ribs that snap or hinge in place.

### BACKGROUND OF THE INVENTION

### 1. Field of the Invention

The present invention relates to an umbrella and specifically to an umbrella which simultaneously provides cover for a human and a pet.

### 2. Description of the Prior Art

It is generally known in the prior art to provide an umbrella with a symmetric double canopy to cover two people, an asymmetric umbrella to cover a one person, an umbrella attached to a pet to cover the pet, or an umbrella attached to a leash to cover a pet.

Prior art patent documents include the following:

U.S. Pat. No. 5,002,080 for “Foldable twin umbrella apparatus” by inventor Ma, filed Mar. 16, 1990 and issued Mar. 26, 1991, is directed to an umbrella having an umbrella cover portion, with a stem portion extending downward for providing the coverage for a single individual as a normal umbrella. Further, there is provided a means for separating the stem portion into two separate stem portions, with a section intermediate the stem portion expandable outward to provide that the single coverage umbrella portion expand to a double coverage umbrella portion, with the stem portions at their lowermost end, either hand held by one of the individuals, or may be separated to be held by both individuals being covered under the expanded fold of the umbrella.

U.S. Pat. No. 5,918,611 for “Animal umbrella” by inventor Amato, filed Apr. 2, 1997 and issued Jul. 6, 1999, is directed to an animal umbrella that is adaptable to a conventional animal harness and collar. The animal umbrella includes a saddle, saddle attaching apparatus, a vertical shank, vertical shank attaching apparatus, and a foldable canopy. The saddle is detachably mounted to the conventional animal harness and is pivotally mounted to the conventional animal collar. The saddle has a lower surface. The saddle attaching apparatus detachably mounts the saddle to the conventional animal harness. The vertical shank has a proximal end with a cross section and a distal end with a cross section. The vertical shank is detachably mounted to the saddle at the proximal end of the vertical shank. The vertical shank attaching apparatus detachably mounts the vertical shank to the saddle. And, the foldable canopy is mounted to the distal end of the vertical shank.

U.S. Pat. No. 6,196,244 for “Configurable umbrella” by inventor Haddad, et al., filed Jan. 19, 1999 and issued Mar. 6, 2001, is directed to umbrellas having various canopy shapes which shapes can be altered during use. A multiple position rib formed of a telescoping rib girder in combination with a hub slide assembly with multiple hubs allow the umbrella to be opened to two or more functional positions. An embodiment is an umbrella that can be used as a car shade having two open canopy configurations. In a first open position, all multiple position ribs are in an extended position so that the umbrella serves as a conventional rain umbrella. In a second open position, at least one of the multiple position ribs is folded to allow the umbrella to fit inside a vehicle windshield thereby serving as a sun shade. The multiple position rib can be formed of a rigid inner support assembly and a flexible outer cantilevered assembly. Flex strength properties of the outer cantilevered assembly can be varied within a rib and between ribs to provide a stable frame for certain unconventionally shaped umbrellas, including domes with flattened centers, asymmetric rib configurations, and ribs of differing lengths. Flex strength properties of the outer cantilevered assembly can be also varied to increase the flexibility of rib ends without compromising open canopy integrity. On contact rib ends can bend down toward the pole altering the shape of the canopy perimeter. The rib ends can return to their original positions when contact is terminated.

U.S. Pat. No. 7,350,530 for “Asymmetric umbrella” by inventor Lisciandro, et al., filed Oct. 29, 2004 and issued Apr. 1, 2008, for an umbrella that includes a canopy, a shaft eccentrically disposed beneath the canopy, a runner slidably mounted on the shaft and slidable between a first position, in which the canopy is collapsed, and a second position, in which the canopy is extended, and rib assemblies forming a canopy supporting frame. Each of the rib assemblies are coupled to the apex of the shaft at a proximal end and to the canopy at a distal end. The rib assemblies include a short main rib assembly having a deployment arm and a rib. In the short main rib assembly, the deployment arm is coupled to the runner and to the rib, and the rib is coupled to the shaft apex and to the deployment arm. The rib assemblies also include a long main rib assembly having a deployment arm, a proximal rib, a connecting arm, and a distal rib. In the long main rib assembly, the deployment arm is coupled to the runner and to the proximal rib, the proximal rib is coupled at one end to the shaft apex and at another end to the connecting arm, and the connecting arm is coupled to the proximal rib and to the distal rib. The distal end of each of the rib assemblies points in the same direction when the canopy is collapsed. The short main rib assembly deployment arm and the long main rib assembly deployment arm are of substantially equal length.

U.S. Pat. No. 7,665,476 for “Asymmetric umbrella” by inventor Lisciandro, et al., filed Oct. 29, 2004 and issued Feb. 23, 2010, is directed to an asymmetric umbrella includes a canopy, a shaft eccentrically disposed beneath the canopy, and a runner slidably mounted on the shaft and slidable between a first position, in which the canopy is collapsed, and a second position in which the canopy is extended. A canopy supporting frame includes rib assemblies each of which has a first end coupled to an apex of the shaft and a second end coupled to the canopy, wherein each of the rib assemblies further comprises a short rib assembly and a long rib assembly.

U.S. Pat. No. 5,086,787 for “Umbrella frame” by inventor Grandjean, et al., filed on Nov. 6, 1989 and issued Feb. 11, 1992, is directed to a frame for an umbrella having a shaft (4,5), ribs (7) extending radially from the top of the shaft, and stretchers (6) extending from a runner (2) on the shaft to attachment points on the ribs. The shaft comprises first and second parts (4,5) connected by a pivot or bending portion, e.g. a joint (1), located at a position between the top of the shaft and the runner (2) to allow the axis of the upper part of the shaft to be set in a position inclined to the axis of the part of the shaft below the pivot. This provides a stable tilting arrangement. Advantageously, the joint (1) can be a snap-in ball joint which is easy to assemble and manipulate.

U.S. Pat. No. 7,021,246 for “Animal umbrella” by Seymour, filed Jan. 6, 2004 and issued Apr. 4, 2006, is directed to an animal umbrella comprising a saddle, straps connected to the saddle for detachably attaching the saddle to the animal, a collapsible canopy, a shaft with first and second ends, connected at the first end to the canopy, and connected at the second end to the saddle in a pivotable manner, and a position lock to releasably secure the shaft in a vertical position. The shaft can be pivoted between a substantially vertical position and a substantially horizontal position, so that in a vertical position the canopy is open and held vertically, and in a horizontal position the canopy is closed and lies horizontally along the animal's back.

U.S. Pat. No. 7,036,519 for “Umbrella and leash for pets” by Godshaw, et al., filed Nov. 7, 2003 and issued May 2, 2006, is directed to combination animal leash and umbrella including a center post with a closeable umbrella cover that fits convexly over the leash attached to the inside of the umbrella. In a preferred embodiment, the extending support post of the umbrella is articulatable.

### SUMMARY OF THE INVENTION

The present invention provides an umbrella extension providing coverage for a human and pet.

It is an object of this invention to provide coverage for the unique shape of both the human and the pet from all elements of nature including all forms of precipitation such as rain, sleet, hail, and snow as well as a barrier from all other elements of nature such as the sun or wind.

These and other aspects of the present invention will become apparent to those skilled in the art after a reading of the following description of the preferred embodiment when considered with the drawings, as they support the claimed invention.

One embodiment of the present invention is an integral asymmetric pet umbrella apparatus including an asymmetric canopy having an asymmetric main canopy and an asymmetric elongated canopy section; a plurality of asymmetric main canopy ribs, wherein each of the plurality of the asymmetric main canopy ribs has a first end and a second end; a plurality of full-size ribs, wherein each of the plurality of the full-size ribs has a first end and a second end; a plurality of deployment rods, each of the plurality of deployment rods having a first end and a second end; a plurality of hinges; a main umbrella shaft having a first end and a second end; and a slider, wherein the slider is slidably attached to the main umbrella shaft, wherein the first end of each of the asymmetric main canopy ribs is attached to the first end of the main umbrella shaft and wherein the second end of each of the asymmetric main canopy ribs is fixed to the edge of the asymmetric main canopy via the second end of each of the asymmetric main canopy ribs, such that the plurality of asymmetric main canopy ribs form a supporting frame for the asymmetric main canopy; wherein the first end of each of the plurality of full-size ribs are attached to the first end of the main umbrella shaft and wherein the second end of each of the plurality of full-sized ribs are fixed to the edge of the asymmetric elongated canopy section, such that the plurality of full-size ribs form a supporting frame for the asymmetric elongated canopy section; wherein the first end of each of the plurality of deployment rods is adjustably attached to the plurality of asymmetric main canopy ribs and the plurality of full-size ribs via hinges, and wherein the second end of each of the plurality of deployment rods is attached to the slider; and wherein the asymmetric main canopy and asymmetric elongated canopy section are formed from a continuous piece of material.

One embodiment of the present invention is a modular pet umbrella extension apparatus for attachment to a plurality of main umbrella ribs including a main canopy extension including an edge; a plurality of modular ribs, wherein each of the plurality of modular ribs includes a first end and a second end; a plurality of extended modular ribs, wherein each of the plurality of the extended modular ribs includes a first end and a second end; and a plurality of fasteners, wherein the plurality of fasteners attach the first end of each of the plurality of modular ribs and the first end of each of the plurality of extended modular ribs to the rib assembly of a main umbrella; and wherein the main canopy extension and the main umbrella form a singular, uninterrupted coverage area for a human and a pet.

Another embodiment of the present invention is a continuous asymmetric canopy umbrella apparatus including an asymmetric canopy having an asymmetric main canopy and a supplemental canopy; a first set of main canopy ribs wherein each rib contains a first end and a second end; a second set of main canopy ribs wherein each rib contains a first end and a second end; a plurality supplemental ribs wherein each rib contains a first end and second end; a plurality of deployment rods wherein each rod contains a first end and a second end; a plurality of hinges; a main umbrella shaft containing a first end and a second end; a slider slidably attached to the main umbrella shaft; and a plurality of supplemental rib connection points, wherein the first end of the first set of main canopy ribs attaches to the first end of the main umbrella shaft, the second end of the first set of main canopy ribs attaches to an edge of the asymmetric main canopy, the first end of the second set of main canopy ribs attaches to the first end of the main umbrella shaft, the second end of the second set of main canopy ribs attaches to the plurality of supplemental rib connection points; wherein the first end of each of the plurality of deployment rods attaches to the slider slidably attached to the main umbrella shaft, where the second end of the plurality of deployment rods attaches to the first set of main canopy ribs and the second set of main canopy ribs via the plurality of hinges; wherein the first end of each of the plurality of supplemental ribs attaches to the plurality of supplemental rib connection points, the second end of the plurality of supplemental ribs attaches to an edge of the supplemental canopy; wherein the asymmetric main canopy and a supplemental canopy are created from a continuous material; wherein when the slider slidably attached to the main umbrella shaft is moved towards the first end of the main umbrella shaft, the plurality of deployment rods move the first set of main canopy ribs and the second set of main canopy ribs open into a deployed state; and wherein the second end of the main umbrella shaft is a handle.

### BRIEF DESCRIPTION OF THE DRAWINGS

FIG. 1 is a side perspective view of a secondary umbrella attached to a main umbrella according to one embodiment of the present invention.

FIG. 2 is a top elevational view of the embodiment illustrated in FIG. 1.

FIG. 3 is a side perspective view of the secondary umbrella illustrated in FIG. 1 and FIG. 2.

FIG. 4 is a side perspective view of a main canopy extension attached to a main canopy of a main umbrella according to one embodiment of the present invention.

FIG. 5 is a top elevational perspective of the embodiment illustrated in FIG. 4.

FIG. 6 is a side perspective view of an integral asymmetric pet umbrella according to one embodiment of the present invention.

FIG. 7 is a side perspective view of the embodiment illustrated in FIG. 6.

FIG. 8 is a cross sectional deployed view of the embodiment illustrated in FIG. 6 and FIG. 7.

FIG. 9 is a cross sectional un-deployed view of the embodiment illustrated in FIG. 6, FIG. 7, and FIG. 8.

FIG. 10 is a top elevational view of a continuous asymmetric pet umbrella according to an embodiment of the present invention.

FIG. 11 is a perspective view of the embodiment illustrated in FIG. 10.

FIG. 12 is an internal perspective view of the embodiment illustrated in FIG. 10 and FIG. 11.

FIG. 13 is a top elevational view of a continuous asymmetric pet umbrella with supplemental rib structure according to an embodiment of the present invention.

FIG. 14 is a perspective view of the embodiment illustrated in FIG. 13.

FIG. 15 is an internal perspective view of the embodiment illustrated in FIG. 13 and FIG. 14.

Referring now to the drawings in general, the illustrations are for the purpose of describing a preferred embodiment of the invention and are not intended to limit the invention thereto.

### DETAILED DESCRIPTION

The present invention is generally directed to umbrella coverage for a human and a pet. All embodiments of this invention provides a unique solution to the problem of protecting a pet from the elements of nature and is distinguished from the prior art by providing this protection using an umbrella that is held upright by a human. Notably, none of the prior art provides for effectively protecting a human and a pet from the elements of nature using an umbrella which is operable to be held upright. Dimensions or ratios of the canopy coverage area relate to the height of the human and size of the pet. Specifically, the present invention is an umbrella that is a combination of two shapes, one for a human and one for the pet. In one embodiment, an extension umbrella for the pet is attached to a main umbrella using a clamp connecting the two shafts and fasteners connecting the ribs of the two canopies. In another embodiment the extension umbrella uses fasteners to extend the standard canopy for a pet and no shaft. In another embodiment, the present invention provides for a retrofit extension usable with a standard or asymmetric umbrella. In yet another embodiment, the present invention utilizes an asymmetric umbrella, which distinguishes from the prior art in that coverage for the human is provided by the smaller portion of the asymmetric umbrella and the larger portion specifically designed for a pet. Preferably, the canopy of the asymmetric umbrella together with the rib assembly maximizes coverage for the human and the pet. The shaft of the asymmetric umbrella is preferably configured to be held by a human and is placed to provide maximum coverage for the human and pet.

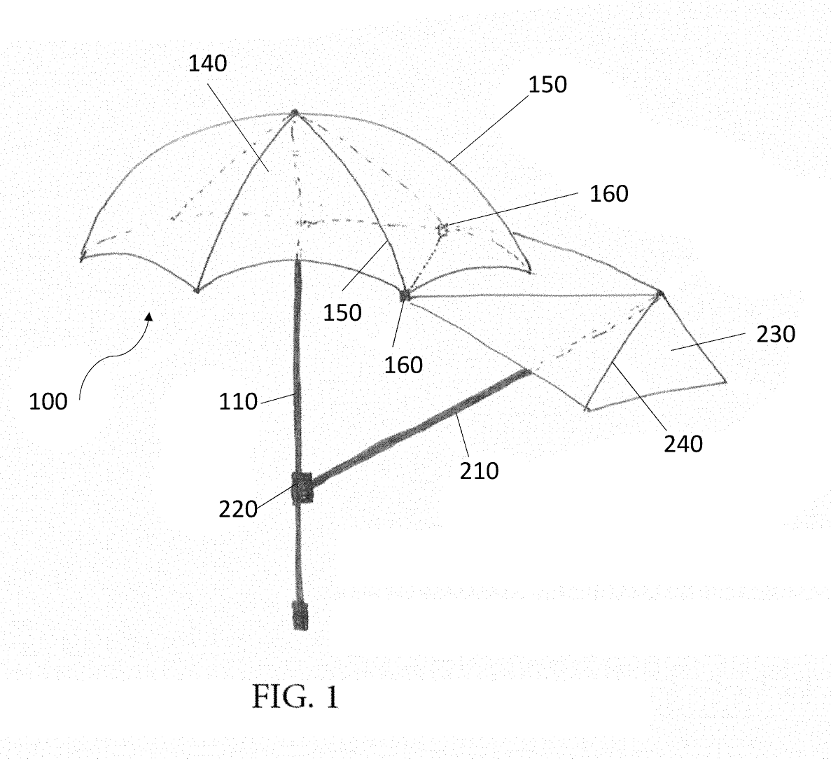

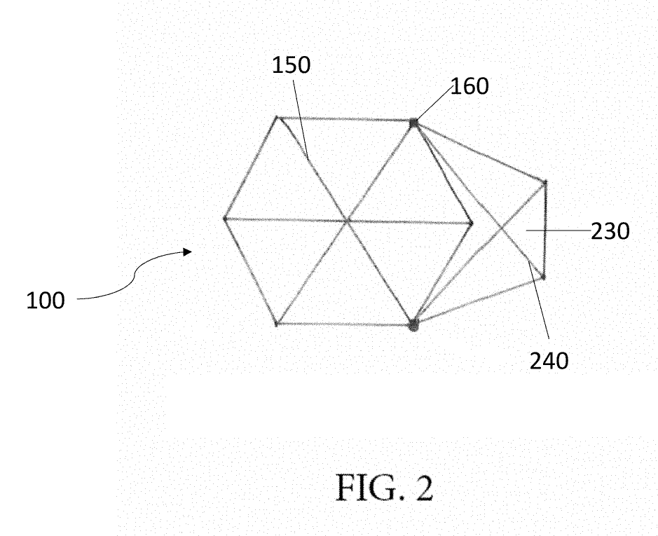

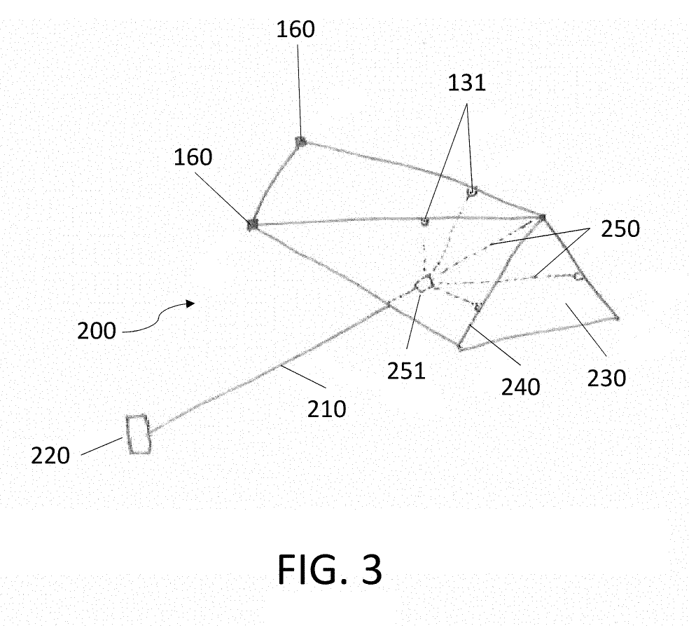

FIG. 1 and FIG. 2 illustrate a modular asymmetric pet umbrella 100. The modular asymmetric pet umbrella 100 includes a main umbrella and a secondary umbrella, with the secondary umbrella illustrated separately in FIG. 3. The secondary umbrella 200, as illustrated in FIG. 3, utilizes a secondary shaft 210 and a clamp 220 to attach to the main umbrella shaft.

FIG. 1 shows the secondary shaft 210 attached to the main umbrella shaft 110 by the clamp 220, thereby extending a secondary canopy 230 with secondary ribs 240 over the pet. Preferably, the secondary shaft 210 incorporates a telescoping feature, allowing for adjustment of the length of the secondary shaft 210, thereby ensuring the secondary canopy 230 lies beneath the main canopy 140. Preferably, the clamp 220 incorporates an adjustable hinge to create an angle with the main umbrella shaft 110 to position the secondary canopy 230 underneath the main canopy 140, thereby creating a continuous, uninterrupted coverage area from rain, sleet, hail, etc. Preferably, the clamp hinge angle is operable between a range of 10 degrees from the horizontal to 80 degrees from the horizontal. Preferably, the clamp 220 has rotational freedom around the main umbrella shaft 110 before attachment, allowing the user to choose the position to best provide coverage underneath the main canopy 140. The secondary canopy 230 can be any shape, preferably beneath the main canopy 140 and fastened with fasteners 160 to the edge of the main canopy 140 as to provide a surface for continuous coverage beyond the surface area of the main canopy 140. The secondary canopy 230 is predominantly supported by the secondary shaft 210. Connecting the secondary canopy 230 with fasteners 160 to the main canopy ribs 150 provides additional structural support and rigidity against rotational stress around the vertical axis. The fasteners 160 utilized to connect the main canopy ribs 150 to the secondary canopy 230 are optional.

FIG. 2 is a top elevational view of the asymmetric pet umbrella 100, showing the main canopy ribs 150 connected to the secondary canopy 230 and secondary ribs 240 via fasteners 160.

FIG. 3 shows the secondary umbrella 200, secondary canopy 230, secondary ribs 240, fasteners 160, a secondary slider 251, clamp 220, secondary deployment rods 250, and hinges 131. The secondary deployment rods 250 are preferably connected to the secondary slider 251 with mechanical fasteners. In an alternative embodiment, the secondary deployment rods 250 are connected to the secondary slider 251 by thermal bonding. In another alternative embodiment, the secondary deployment rods 250 are connected to the secondary slider 251 by adhesive.

In an embodiment of the present invention, the coverage area of the main canopy 140 and the secondary canopy 230 is a coverage area for the human and a coverage area for the pet. In an embodiment of the present invention, the secondary canopy 230 is a general size and shape for a class of pet or a specific shape for a specific class or breed of pet and the ratios of coverage area between human and pet decrease as the size of the pet or coverage area needed for the pet increases. For example, a small coverage area appropriate for a human and breeds of dog such as, but not limited to, Affenpinscher, Cairn Terrier, German Spitz—miniature (Kleinspitz), Havanese, Japanese Chin, Maltese, Norfolk Terrier, Pekingese, Pomeranian, Scottish Terrier, Shih Tzu, Sky Terrier, Silky Terrier, Toy Poodle, Toy Fox Terrier, West Highland, White Terrier, or Yorkshire Terrier, have a coverage ratio of the diameter or width of circular or other shaped portion of the main canopy for the human versus the width of the elliptical or other shaped portion for the pet of about 2.56 to about 3.5, preferably about 3.146. Medium sized breeds such as, but not limited to, Pitbull Terrier, Australian Cattle Dog, Australian Kelpie, Australian Shepherd, Australian Stumpy Tail Cattle Dog, Australian Black and Tan Hound, Barbet, Bearded Collie, Border Collie, Bull Terrier, Canaan Dog, Catalonian Sheepdog, Cirneco dell'Etna, or Dalmatian, have a coverage ratio of the diameter of the circular or other shaped portion of the main canopy for the human versus the width of the elliptical or other shaped portion for the pet of about 2.25 to about 3.0, preferably about 2.68. For large sized breeds such as, but not limited to, Akbash Dog, Anatolian Shepherd Dog, Great Dane, Irish Wolfhound, Polish Greyhound, Scottish Deerhound, or Spanish Mastiff, have a coverage ratio of the diameter of the circular or other shaped portion of the main canopy for the human versus the width of the elliptical or other shaped portion for the pet of about 2.0 to about 2.68, preferably about 2.25.

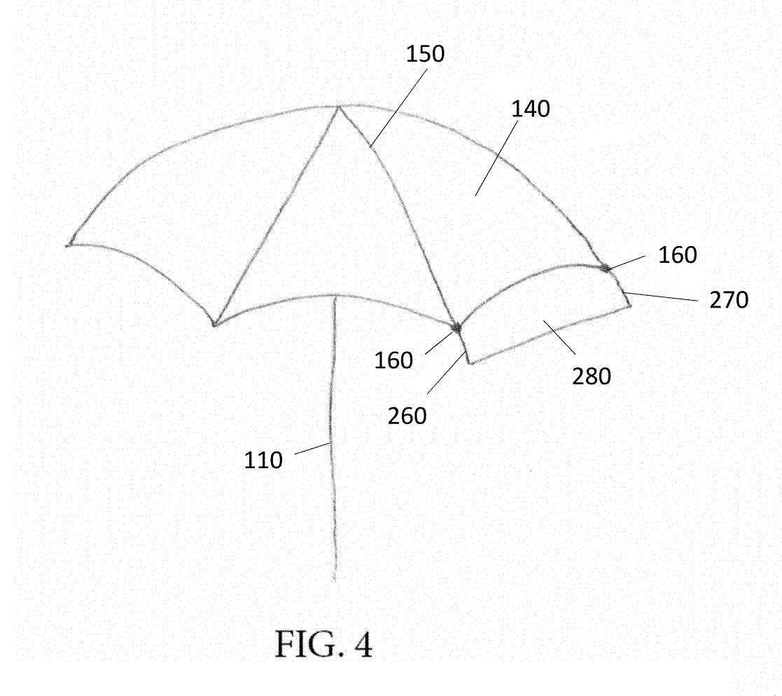

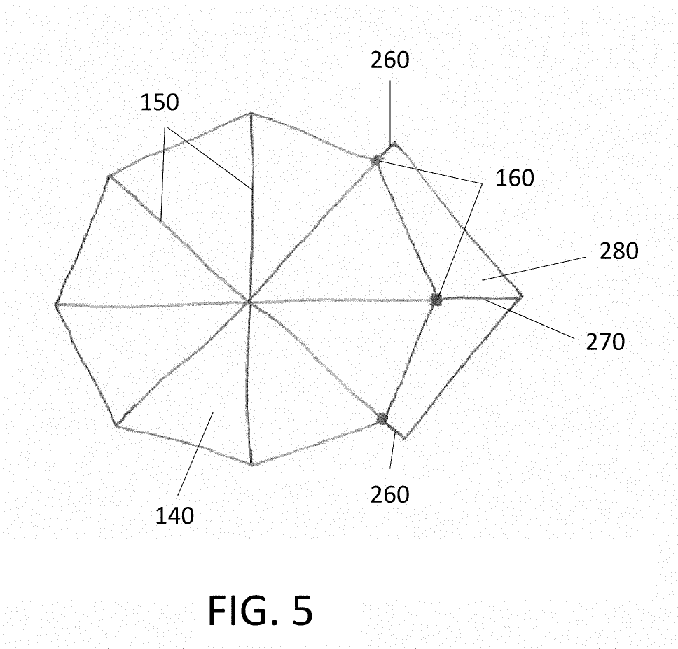

Another embodiment of the present invention includes a main canopy extension 280, as illustrated in FIG. 4 and FIG. 5. FIG. 4 and FIG. 5 show a main canopy extension 280 attached to the main canopy 140 of the main umbrella, wherein the main canopy extension 280 provides coverage for a pet.

As illustrated in FIG. 4, the main canopy 140 connects to a main umbrella shaft 110 and includes main canopy ribs 150, and the main canopy extension 280 includes modular ribs 260 and extended modular ribs 270. The extended modular ribs 270 are a different length than the modular ribs 260. The modular ribs 260 and extended modular ribs 270 are latched or fastened with fasteners 160 to the main canopy ribs 150, giving shape to the main canopy extension 280. In a preferred embodiment the fasteners 160 are spring assisted hinges. The spring assisted hinges allow the main canopy extension 280 to be folded under the main canopy 140 when not in use, and the spring assisted hinges further allow the main canopy extension 280 to be deployed automatically upon unfurling of the main umbrella. The coverage area created by the main canopy 140 and the main canopy extension 280 is continuous and uninterrupted, thereby providing protection against rain, snow, sleet, hail, etc. The size of the modular ribs 260 and the size of the extended modular ribs 270 are determined by the required size of the main canopy extension 280 in order to adequately protect the individual pet. The shape of the main canopy extension 280 includes, but is not limited to, an ellipse, a trapezoid, a rhombus, or a triangle.

FIG. 5 shows a top elevational perspective of the main canopy extension 280 attached to a main canopy 140 of a main umbrella according to one embodiment of the present invention, including the main canopy 140, the main canopy ribs 150, fasteners 160, modular ribs 260, extended modular ribs 270, and main canopy extension 280.

The fasteners 160, used in FIG. 1-FIG. 6 are preferably mechanical fasteners, including but not limited to, clamps, hooks, clips, and magnets.

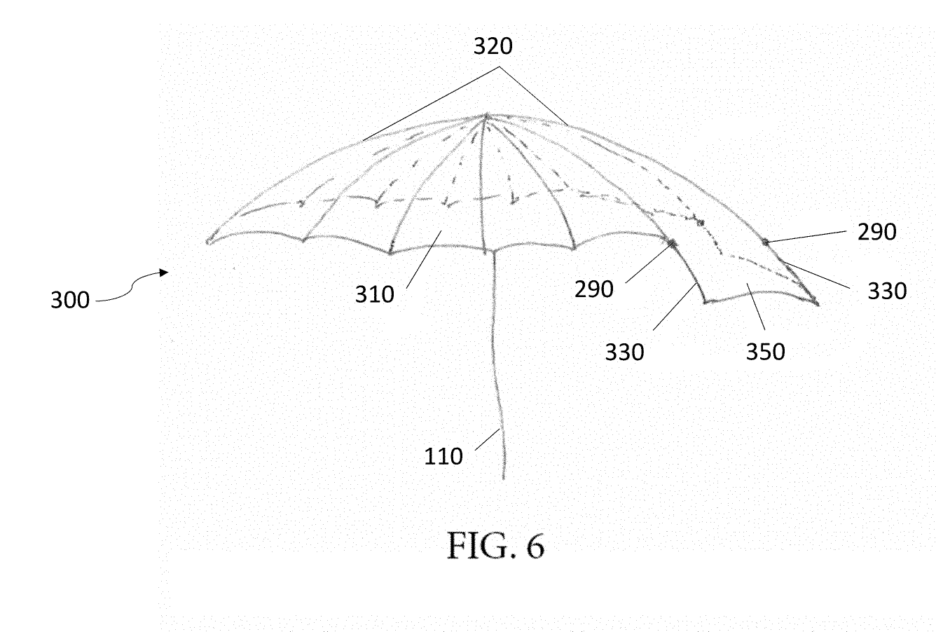

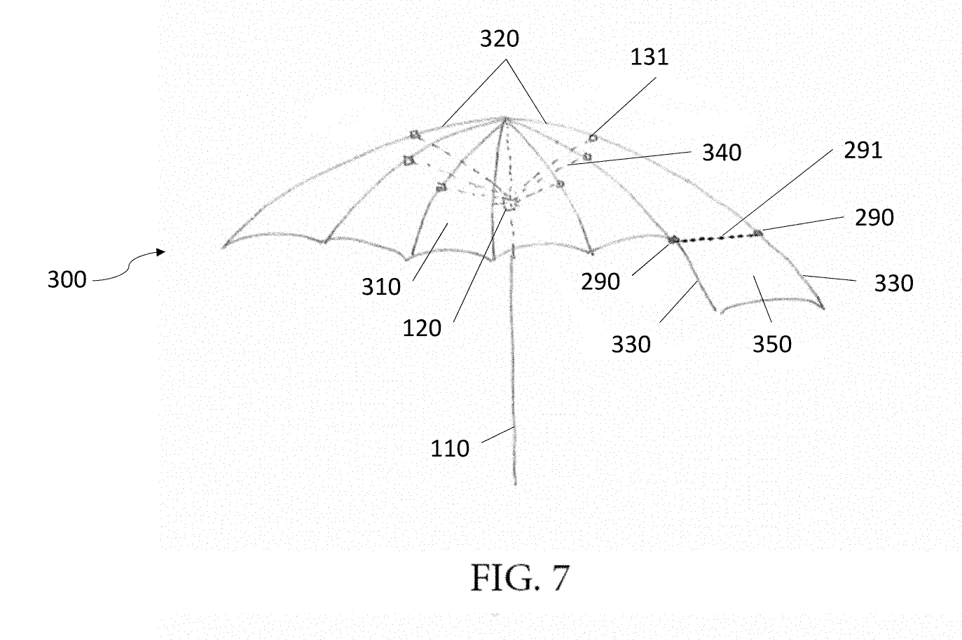

Another embodiment of the present invention includes an integral asymmetric pet umbrella designed to efficiently protect a human and a pet, as illustrated in FIG. 6 and FIG. 7.

FIG. 6 shows the integral asymmetric pet umbrella 300 including asymmetric main canopy ribs 320 and asymmetric main canopy elongated ribs 330, with the ribs forming a supporting structure for an asymmetric main canopy 310 and an asymmetric elongated canopy section 350, wherein the end of the asymmetric main canopy ribs 320 is capable of fitting into the end of the asymmetric main canopy elongated ribs 330. In one embodiment of the present invention, the asymmetric main canopy ribs 320 and asymmetric main canopy elongated ribs 330 that connect together incorporate an elastic cord holding them together. The elastic cord provides tension to ensure a tight fit between the connected ribs, and the elastic cord further ensures that the asymmetric main canopy elongated ribs 330 do not get misplaced when in the furled position. Alternatively, the asymmetric main canopy ribs 320 are attached to the asymmetric main canopy elongated ribs 330 via a lockable hinge 290, thereby allowing the asymmetric elongated canopy section 350 to fold under when not in use.

FIG. 7 shows an internal side perspective view of the integral asymmetric pet umbrella 300, including the slider 120, asymmetric main canopy deployment rods 340, and hinges 131. The asymmetric main canopy deployment rods 340 each have a first end and a second end. The first end of each of the asymmetric main canopy deployment rods 340 are connected to the asymmetric main canopy ribs 320 and asymmetric main canopy elongated ribs 330 with hinges 131, wherein the hinges are operable to slide along the asymmetric main canopy ribs 320 and asymmetric main canopy elongated ribs 330 to aid in furling and unfurling of the integral asymmetric pet umbrella. The second end of the asymmetric main canopy deployment rods 340 are connected to a slider 120, thereby providing support for the asymmetric main canopy ribs 320 when the umbrella is deployed, and serving to deploy the asymmetric main canopy ribs 320 from the un-deployed state. In a preferred embodiment, the asymmetric main canopy 310 and the asymmetric elongated canopy section 350 are formed from the same piece of material. The boundary line 291, separates the two portions of the continuous canopy into the central portion (asymmetric main canopy 310), and the peripheral section (asymmetric elongated canopy section 350). The boundary line 291 intersects the lockable hinges 290 and extends along the entire edge of the asymmetric elongated canopy section 350.

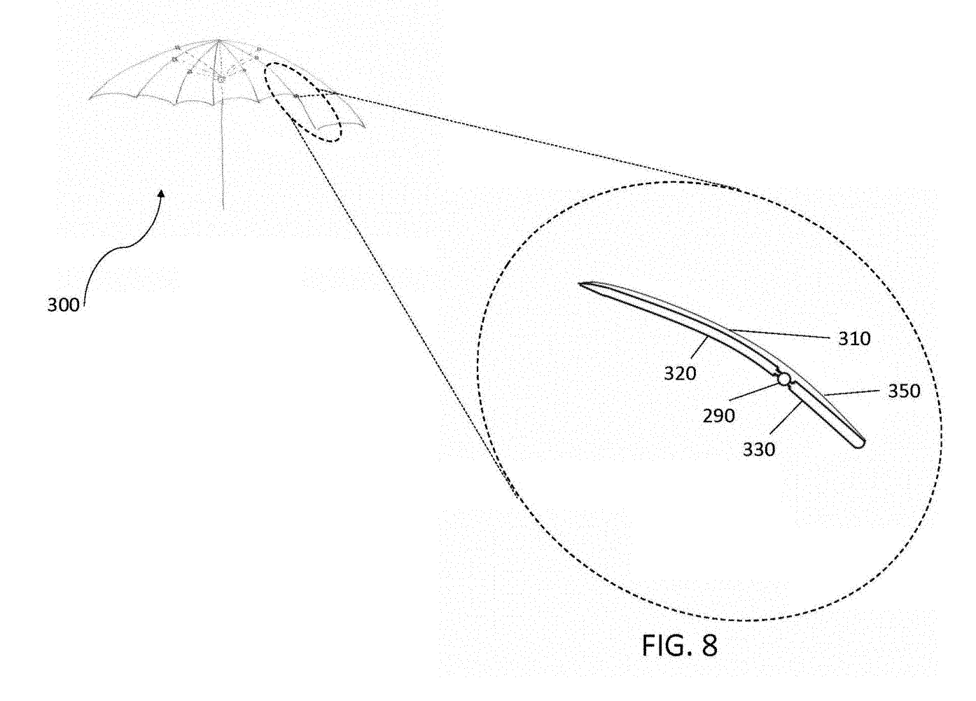

FIG. 8 illustrates a cross sectional view of a portion of the integral asymmetric pet umbrella 300 in a deployed position, illustrating one asymmetric main canopy rib 320, an asymmetric main canopy elongated rib 330, a lockable hinge 290, asymmetric main canopy 310, and asymmetric elongated canopy section 350.

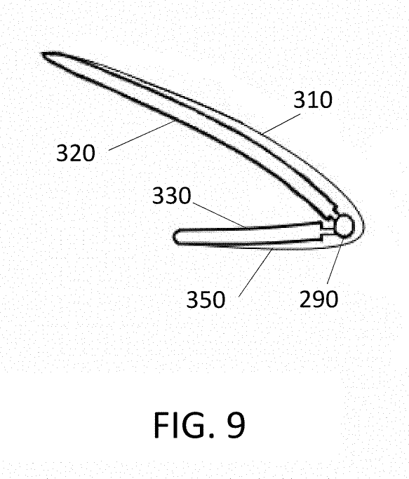

FIG. 9 illustrates a cross sectional view of an asymmetric main canopy elongated rib 330 in an un-deployed state or folded position, illustrating an asymmetric main canopy rib 320, a section of the asymmetric main canopy 310, an asymmetric main canopy elongated rib 330, the asymmetric elongated canopy section 350, and a lockable hinge 290. As illustrated in FIG. 8 and FIG. 9, the asymmetric main canopy 310 and asymmetric elongated canopy section 350 are integrally formed from one continuous piece of material allowing for easy storage when the asymmetric main canopy elongated ribs 330 are in the un-deployed state.

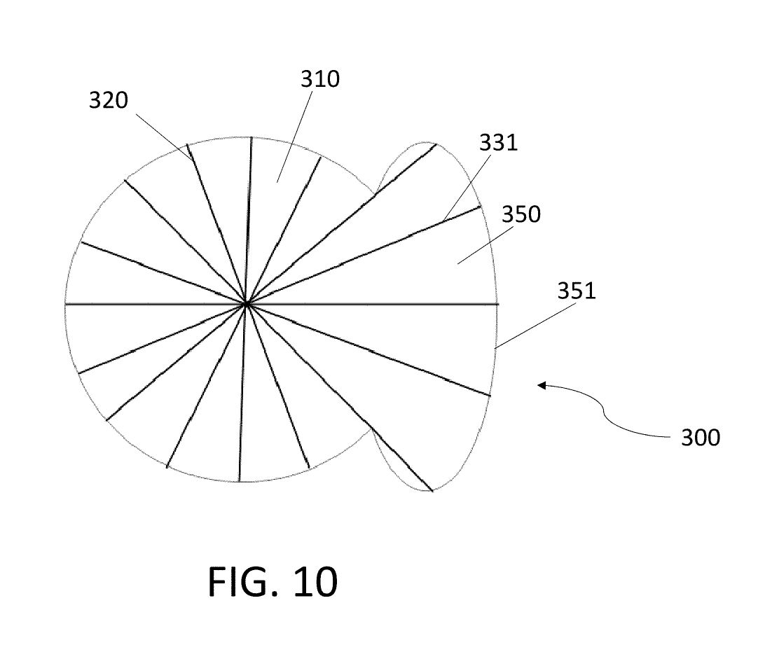

FIG. 10 shows a top down view of an integral asymmetric pet umbrella 300 including an asymmetric elongated canopy section 350, asymmetric main canopy ribs 320, asymmetric main canopy 310, asymmetric full-size ribs 331, and tensioning feature 351, wherein the asymmetric elongated canopy section 350 is shaped to efficiently cover the form of a dog, preferably oval shaped.

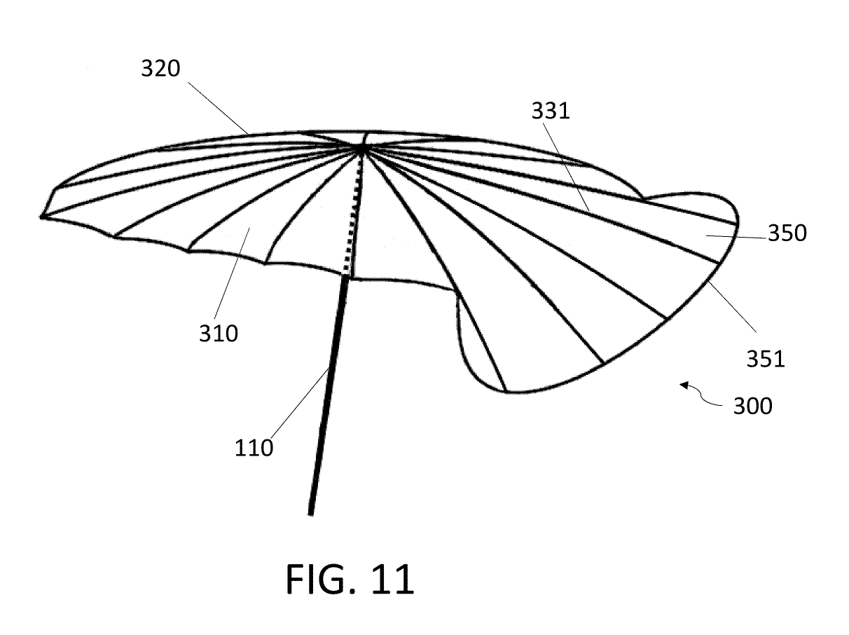

FIG. 11 shows a side perspective view of the integral asymmetric pet umbrella 300 illustrated in FIG. 10, further showing the main canopy shaft 110.

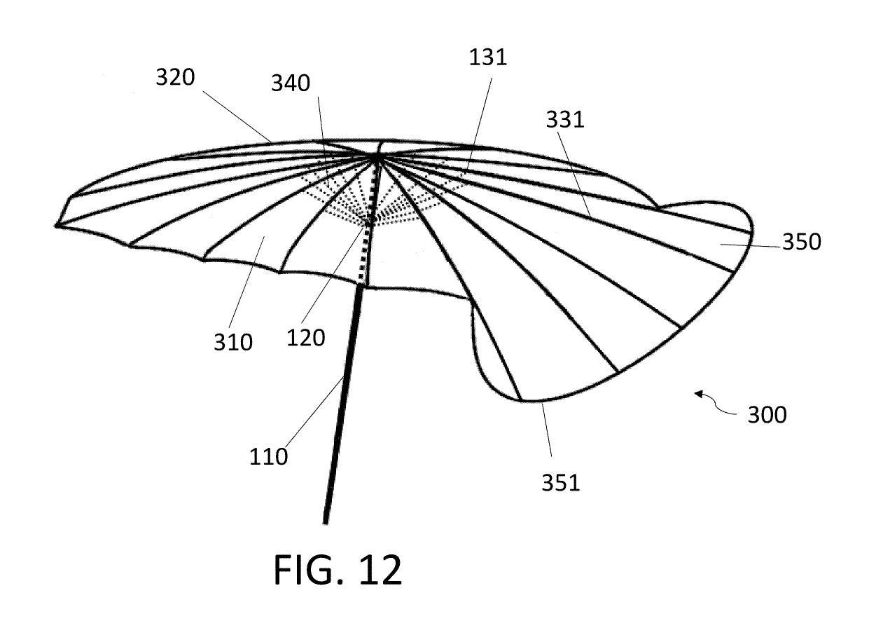

FIG. 12 shows a side perspective view of the integral asymmetric pet umbrella 300 illustrated in FIG. 10 and FIG. 11, further showing the asymmetric main canopy deployment rods 340, and slider 120.

In a preferred embodiment the shape of the canopies (main canopy, secondary canopy, main canopy extension, asymmetric main canopy, supplemental canopy etc.) is such that a human is protected from the elements as well as a pet that is walking alongside the human as is shown, by way of example and not limitation, in FIG. 10.

In a preferred embodiment, there are between eight and sixteen ribs (including main canopy ribs, secondary ribs, asymmetric main canopy ribs, asymmetric main canopy elongated ribs, asymmetric full-size ribs, supplemental ribs, etc.).

In another embodiment there are sixteen ribs total in the asymmetric pet umbrella. Alternatively, there are between eight and twelve ribs total in the asymmetric pet umbrella. In another embodiment, there are between sixteen and twenty-three ribs total in the asymmetric pet umbrella. In an alternative embodiment, the number of ribs is dictated by the predetermined use of the invention, including but not limited to, the size of the pet, the size of the human, the required structural rigidity, etc.

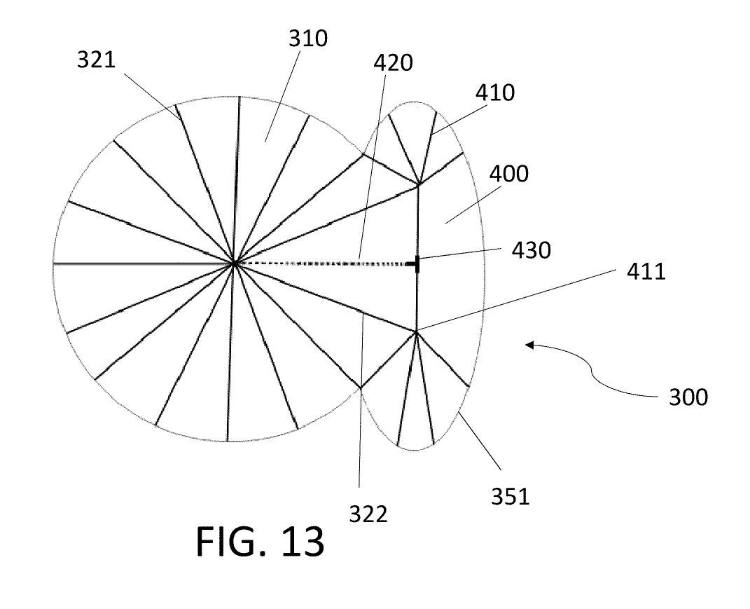

FIG. 13 illustrates a top down view of another embodiment of the integral asymmetric pet umbrella 300 shaped to efficiently protect a human and a pet, wherein the integral asymmetric pet umbrella 300 contains a singular piece of material that forms both an asymmetric main canopy 310 and a supplemental canopy 400. This embodiment of the present invention incorporates a dual rib structure design, thereby enhancing structural rigidity and allowing for larger supplemental canopies 400. This embodiment includes a first set of main canopy ribs 321, a second set of main canopy ribs 322, supplemental ribs 410, supplemental rib connection points 410, tensioning feature 351, supplemental deployment rod 420, and a T-joint 430.

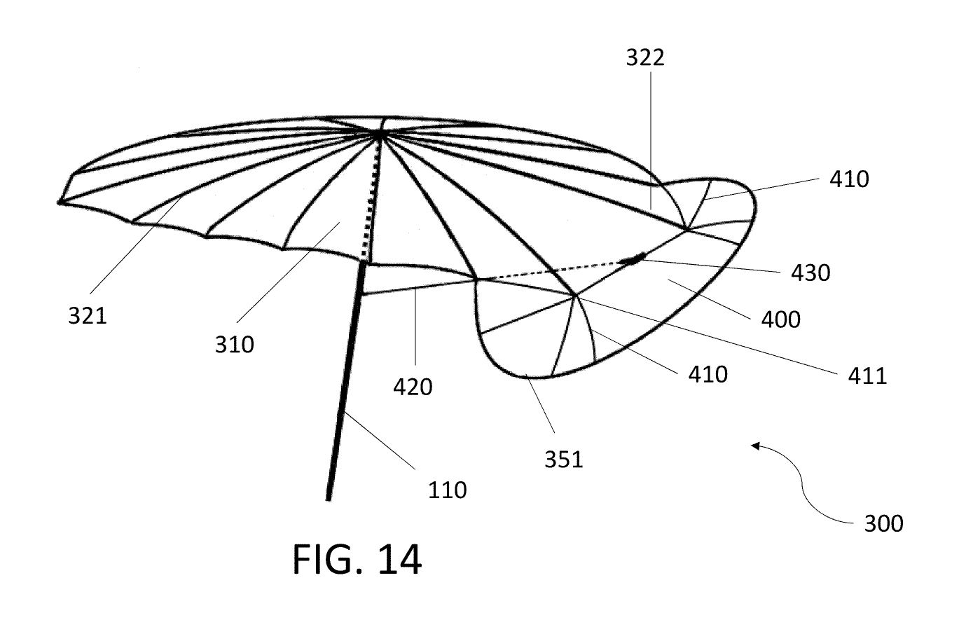

FIG. 14 shows a side perspective view of the integral asymmetric pet umbrella 300 illustrated in FIG. 13, further showing a main umbrella shaft 110.

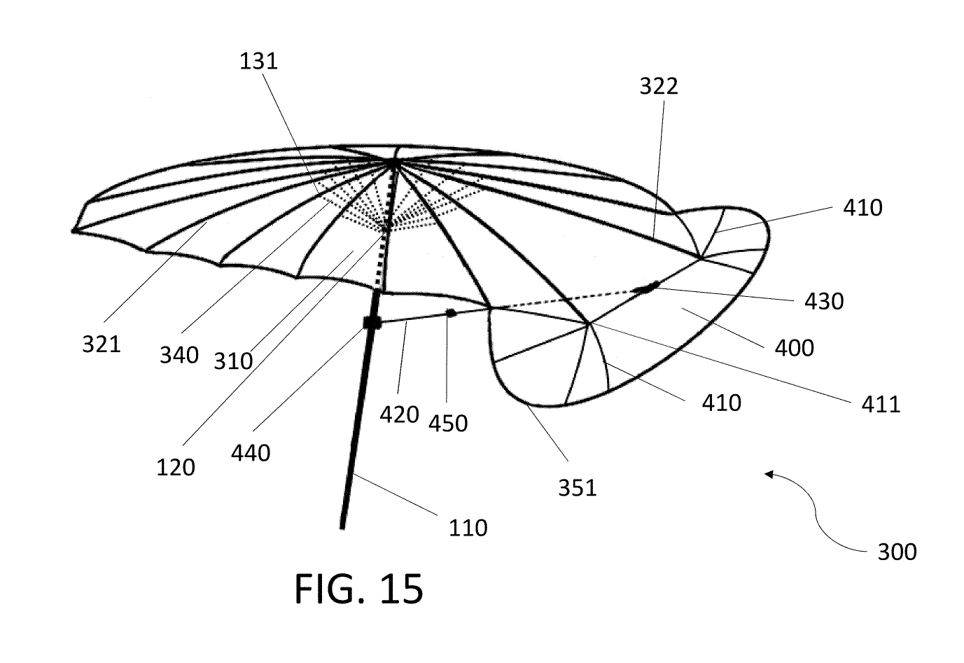

FIG. 15 shows a side perspective view of the integral asymmetric pet umbrella 300 illustrated in FIG. 13 and FIG. 14, further showing a supplemental slider 440, a supplemental deployment rod slider 450, hinges 131, slider 120, and asymmetric main canopy deployment rods 340. The asymmetric main canopy 310 is supported by a first set of main canopy ribs 321 and a second set of main canopy ribs 322. The asymmetric main canopy deployment rods 340 each have a first end and a second end. The first end of each of the asymmetric main canopy deployment rods 340 is attached to the hinges 131 on the first set of main canopy ribs 321 and the second set of main canopy ribs 322, and the second end of the asymmetric main canopy deployment rods 340 attaches to the slider 120. The first set of main canopy ribs 321 and a second set of main canopy ribs 322 each have a first end and a second end. The first end of the first set of main canopy ribs 321 and the first end of the second set of main canopy ribs 322 attach at the first end of the main umbrella shaft 110. The second end of the first set of main canopy ribs 321 attaches to the edge of the asymmetric main canopy 310. The second end of the second set of main canopy ribs 322 attaches to one of the at least two supplemental rib connection points 411. The supplemental ribs 410 have a first end and a second end. The first end of the supplemental ribs 410 attach at one of the two supplemental rib connection points 411. The second end of the supplemental ribs 410 attach at a predetermined point along the edge of the supplemental canopy 400. The two supplemental rib connection points 411 are connected by a supplemental rib 410 that includes a T-joint 430. This T-joint 430 provides a connection point for a supplemental deployment rod 420. The supplemental deployment rod 420 provides additional support to the supplemental canopy 400. The supplemental deployment rod 420 has a first end and a second end. The first end of the supplemental deployment rod 420 connects with the T-joint 430. The second end of the supplemental deployment rod 420 attaches to a supplemental slider 440 that is located on the main umbrella shaft 110. The supplemental slider 440 assists in the deployment and support of the supplemental canopy 400. The supplemental deployment rod 420 is disconnected prior to the integral asymmetric pet umbrella 300 being placed in the un-deployed state. In an alternative embodiment, the supplemental deployment rod 420 incorporates a supplemental deployment rod slider 450 that allows the supplemental deployment rod 420 to telescope within itself, thereby allowing the supplemental deployment rod 420 to remain attached to the T-joint 430 while the integral asymmetric pet umbrella 300 is in both a deployed and un-deployed state. The combination of the supplemental ribs 410 and the supplemental deployment rod 420 enhance the integral asymmetric pet umbrella's 300 structural rigidity and is therefore advantageous over the prior art.

In an alternative embodiment, the present invention includes a dual-canopy design to increase the present invention's rigidity against wind gusts.

In an alternative embodiment, the present invention includes a main umbrella shaft with a first end and a second end, wherein the first end is a connection point for the plurality of ribs and the second end is an integral handle.

In an alternative to the embodiment illustrated in FIG. 13-FIG. 15, the present invention includes a decorative covering that drapes over the supplemental canopy 400. The decorative covering attaches with fasteners to the supplemental rib connection points 411. The decorative covering provides a method of decorating the supplemental canopy in a non-permanent way. In a preferred embodiment, the decorative covering is sold separately and is utilized as an accessory for users to personalize their asymmetric pet umbrella. By way of example and not limitation, the decorative covering includes legs and droopy ears that fall past the edge of the canopy, thereby clearly representing the supplemental canopy as being designed to cover the pet.

The ribs (main canopy ribs, secondary ribs, modular ribs, extended modular ribs, asymmetric main canopy ribs, asymmetric main canopy elongated ribs, asymmetrical full-size ribs, supplemental ribs, etc.) are preferably created out of metal, by way of example and not limitation, steel, aluminum, and/or titanium. Alternatively the ribs are created out of a non-metal material, by way of example and not limitation, plastic, carbon fiber, and/or ceramics.

The shaft (main umbrella shaft, secondary shaft, etc.) is preferably made out of metal, by way of example and not limitation, steel, aluminum, and/or titanium. Alternatively the shaft is created out of a non-metal material, by way of example and not limitation, plastic, carbon fiber, and/or ceramics.

The deployment rods (deployment rods, secondary deployment rods, asymmetric main canopy deployment rods, supplemental deployment rod, etc.) are preferably created out of metal, by way of example and not limitation, steel, aluminum, and/or titanium. Alternatively the deployment rods are created out of a non-metal material, by way of example and not limitation, plastic, carbon fiber, and/or ceramics.

In one embodiment the canopies (main canopy, secondary canopy, main canopy extension, asymmetric main canopy, asymmetric elongated canopy section, supplemental canopy, etc.) are a waterproof material, including but not limited to nylon taffeta and/or acetate. In another embodiment the canopies are constructed of a material designed to block the sun, including but not limited to nylon and/or polyester.

In another embodiment of the present invention, the edges of the canopies (main canopy, secondary canopy, main canopy extension, asymmetric main canopy, asymmetric elongated canopy section, supplemental canopy, etc.) incorporate an internal tensioning feature 351 as illustrated in FIG. 10-FIG. 15. The internal tensioning feature 351 provides additional rigidity to the canopy, as well as ensures the desired shape of the canopy. The internal tensioning feature 351 is created by utilizing, by way of example and not limitation, wire and/or elastic cords. The internal tensioning feature 351 is designed to ensure the shape of the edges of the canopies (main canopy, secondary canopy, main canopy extension, asymmetric main canopy, asymmetric elongated canopy section, supplemental canopy, etc.), and the internal tensioning feature 351 is further designed to ensure the canopies are rigid enough to support interchangeable decorative coverings. In an embodiment where the internal tensioning feature 351 is a wire, the shape and rigidity of the canopy edges is independent of whether the canopy is furled or unfurled. In an embodiment of the present invention where the internal tensioning feature 351 is an elastic cord, the shape and rigidity of the canopy edges is depended on whether the canopy is furled or unfurled. Specifically, the elastic cord is pulled taught as the canopy is deployed, thereby separating the rib structures from each other and increasing the distance between the rib ends. This increase in separation pulls the elastic cord into the predetermined position and ensures the shape of the canopy edge.

As a variation to the illustrated embodiments, the main umbrella is previously designed to attach an extension canopy which snaps into place modularly, attach through a hinge, or fashioned to attach through a connection point.

Another aspect of the invention is the size of the secondary canopy or main canopy extension used with an existing model of an asymmetric umbrella or main umbrella to provide coverage for a pet. The secondary canopy or main canopy extension can provide coverage for pets of all sizes including but not limited to small, medium, or large. The secondary canopy or main canopy extension can be attached structurally to the main umbrella canopy, as an extension to the ribs, or extending from the structure of the shaft assembly.

Another aspect of the invention is the balance, weight, and center-of-gravity of the canopy assembly as held by the human. The angle of the main umbrella shaft and amount of cover above the human versus pet is adjusted to balance the center of gravity of the secondary umbrella depending on the on the ratios between human and pet and size of the secondary canopy.

Another aspect of the present invention is an adjustment to the length and positioning of the secondary umbrella in relation to the shape of the main canopy and in relation to the direction of motion of the human and pet. Examples include, but are not limited to, where the pet is beside the human, the pet is behind the human, and the pet is in front of the human.

Another aspect of the invention is an attachment to the umbrella to provide a clear visual clue to the human and the pet regarding the limits of the coverage area.

Another aspect of the invention is a strap of a given length to wrap around the umbrella and secure the main canopy to the main umbrella shaft in an un-deployed position. Also included in the present invention, is a mechanism to bring the same strap of a given length into the underside of the umbrella where it is attached to the shaft and the pet, thereby limiting the pet's freedom of movement to the coverage area below the asymmetric pet umbrella. Alternatively, the main umbrella shaft includes a loop that can fit variable leash thicknesses, thereby providing a mounting location on the umbrella to limit the pet's mobility to within the coverage area of the pet umbrella.

Another aspect of the invention is a visual clue that this is a pet umbrella operated by a human, by providing screen prints on the canopy of pets or pet related images including but not limited to a picture of a goofy happy dog, a librarian dog, a sporty dog, etc.

Another aspect of the invention is an asymmetric pet umbrella for a human and specific species or breed of pet including but not limited to an asymmetric pet umbrella for a human and small dog such as Pug, Poodle, or Pomeranian; or an asymmetric pet umbrella for a human and large dog such as a Great Dane, Neapolitan Mastiff, or Newfoundland.

Another aspect of the invention is an asymmetric pet umbrella that makes a specific shape for a particular type or size of pet including but not limited to a circular main canopy for a human combined with an elliptical secondary canopy for the pet. All shapes and combinations are possibilities for providing coverage for human and pet including circles, ellipses, squares, triangles, or all types of polygons. The shapes also have a vertical dimension when in the deployed position, the canopies (main canopy, secondary canopy, main canopy extension, asymmetric main canopy, asymmetric elongated canopy section, supplemental canopy, etc.) look like a half bubble, a crescent moon shape, or anything in between.

In yet another aspect of the present invention, the shaft of the umbrella is off-center to provide balance for the asymmetric pet umbrella. In one embodiment, the plurality of full-size ribs are different lengths to account for the off-center umbrella shaft.

The above-mentioned examples are provided to serve the purpose of clarifying the aspects of the invention, and it will be apparent to one skilled in the art that they do not serve to limit the scope of the invention. By way of example, the handle may pivot in multiple axes. Also by way of example, the ribs (main canopy ribs, secondary ribs, asymmetric main canopy ribs, asymmetric main canopy elongated ribs, asymmetric full-size ribs, supplemental ribs, etc.) may be solid. By nature, this invention is highly adjustable, customizable and adaptable. The above-mention examples are is just some of the many configurations that the mentioned components can take on. All modifications and improvements have been deleted herein for the sake of conciseness and readability but are properly within the scope of the present invention.

1. An integral asymmetric pet umbrella apparatus comprising:
an asymmetric canopy having an asymmetric main canopy and an asymmetric elongated canopy section;
a plurality of asymmetric main canopy ribs, wherein each of the plurality of the asymmetric main canopy ribs has a first end and a second end;
a plurality of full-size ribs, wherein each of the plurality of the full-size ribs has a first end and a second end;
a plurality of deployment rods, each of the plurality of deployment rods having a first end and a second end;
a plurality of hinges;
a main umbrella shaft having a first end and a second end; and
a slider, wherein the slider is slidably attached to the main umbrella shaft,
wherein the first end of each of the asymmetric main canopy ribs is attached to the first end of the main umbrella shaft and wherein the second end of each of the asymmetric main canopy ribs is fixed to the edge of the asymmetric main canopy via the second end of each of the asymmetric main canopy ribs, such that the plurality of asymmetric main canopy ribs form a supporting frame for the asymmetric main canopy;
wherein the first end of each of the plurality of full-size ribs are attached to the first end of the main umbrella shaft and wherein the second end of each of the plurality of full-sized ribs are fixed to the edge of the asymmetric elongated canopy section, such that the plurality of full-size ribs form a supporting frame for the asymmetric elongated canopy section;
wherein the first end of each of the plurality of deployment rods is adjustably attached to the plurality of asymmetric main canopy ribs and the plurality of full-size ribs via hinges, and wherein the second end of each of the plurality of deployment rods is attached to the slider; and
wherein the asymmetric main canopy and asymmetric elongated canopy section are formed from a continuous piece of material.

2. (canceled)

3. The integral asymmetric pet umbrella apparatus of claim 1, wherein the edge of the asymmetric main canopy and asymmetric elongated canopy section incorporate an integral tensioning feature made of wire or elastic cord, wherein the integral tensioning feature maintains the canopy edge shape and enhances structural rigidity.

4. The integral asymmetric pet umbrella apparatus of claim 1, wherein the asymmetrical main canopy is circular, elliptical, or polygonal.

5. The integral asymmetric pet umbrella apparatus of claim 1, wherein the integral asymmetric pet umbrella apparatus is adjustable from a closed position to an opened position by sliding the slider up the main umbrella shaft towards the first end of the shaft, thereby extending the plurality of deployment rods, and pushing against the plurality of asymmetric main canopy ribs and plurality of full-size ribs through the connection at the hinges, wherein the hinge locations on the plurality of asymmetric main canopy ribs and plurality of full-size ribs are positioned to ensure simultaneous deployment of the asymmetric main canopy and asymmetric elongated canopy section.

6. The integral asymmetric pet umbrella apparatus of claim 1, wherein the shaft is composed of a plurality of telescoping rods and the shaft is adjustable.

7. The integral asymmetric pet umbrella apparatus of claim 1, wherein the asymmetric elongated canopy section incorporates an interchangeable decorative covering.

8. A modular pet umbrella extension apparatus for attachment to a plurality of main umbrella ribs comprising:
a main canopy extension including an edge;
a plurality of modular ribs, wherein each of the plurality of modular ribs includes a first end and a second end;
a plurality of extended modular ribs, wherein each of the plurality of the extended modular ribs includes a first end and a second end; and
a plurality of fasteners,
wherein the plurality of fasteners attach the first end of each of the plurality of modular ribs and the first end of each of the plurality of extended modular ribs to the rib assembly of a main umbrella; and
wherein the main canopy extension and the main umbrella form a singular, uninterrupted coverage area for a human and a pet.

9. The modular pet umbrella extension apparatus of claim 8, wherein the edge of the main canopy extension overlaps underneath the edge of a main umbrella canopy of a main umbrella.

10. The modular pet umbrella extension apparatus of claim 8, wherein the at least one of the plurality of fasteners is magnetic.

11. The modular pet umbrella extension apparatus of claim 8, wherein the at least one of the plurality of fasteners is a lockable hinge, thereby allowing the main canopy extension to fold underneath the main canopy of the main umbrella when not in use.

12. The modular pet umbrella extension apparatus of claim 8, wherein the umbrella extension apparatus includes a spring, wherein the modular pet umbrella extension is operable to deploy upon deployment of the main umbrella.

13. The modular pet umbrella extension apparatus of claim 8, wherein the edge of the main canopy extensions contains an integral tensioning feature of wire or elastic cord, wherein the integral tensioning feature maintains the canopy edge shape and enhances structural rigidity.

14. A continuous asymmetric canopy umbrella apparatus comprising:
an asymmetric canopy having an asymmetric main canopy and a supplemental canopy;
a first set of main canopy ribs wherein each rib contains a first end and a second end;
a second set of main canopy ribs wherein each rib contains a first end and a second end;
a plurality supplemental ribs wherein each rib contains a first end and second end;
a plurality of deployment rods wherein each rod contains a first end and a second end;
a plurality of hinges;
a main umbrella shaft containing a first end and a second end;
a slider slidably attached to the main umbrella shaft; and
a plurality of supplemental rib connection points,
wherein the first end of the first set of main canopy ribs attaches to the first end of the main umbrella shaft, the second end of the first set of main canopy ribs attaches to an edge of the asymmetric main canopy, the first end of the second set of main canopy ribs attaches to the first end of the main umbrella shaft, the second end of the second set of main canopy ribs attaches to the plurality of supplemental rib connection points;
wherein the first end of each of the plurality of deployment rods attaches to the slider slidably attached to the main umbrella shaft, where the second end of the plurality of deployment rods attaches to the first set of main canopy ribs and the second set of main canopy ribs via the plurality of hinges;
wherein the first end of each of the plurality of supplemental ribs attaches to the plurality of supplemental rib connection points, the second end of the plurality of supplemental ribs attaches to an edge of the supplemental canopy;
wherein the asymmetric main canopy and a supplemental canopy are created from a continuous material;
wherein when the slider slidably attached to the main umbrella shaft is moved towards the first end of the main umbrella shaft, the plurality of deployment rods move the first set of main canopy ribs and the second set of main canopy ribs open into a deployed state; and
wherein the second end of the main umbrella shaft is a handle.

15. The continuous asymmetric canopy umbrella apparatus of claim 14, further comprising:
a T-joint;
a supplemental slider slidably attached to the main umbrella shaft;
a supplemental deployment rod containing a first end and a second end;
wherein the second end of the supplemental deployment rod attaches to the supplemental slider slidably attached to the main umbrella shaft, the first end of the supplemental deployment rod attaches to the T-joint, wherein the T-joint intersects the supplemental rib that connects the plurality of supplemental rib connection points.

16. The continuous asymmetric canopy umbrella apparatus of claim 15, further comprising:
a supplemental deployment rod slider;
wherein the supplemental deployment rod slider is slidably attached to the supplemental deployment rod, allowing the supplemental rod to contract within itself and thereby allowing the continuous asymmetric canopy umbrella apparatus to transition from the deployed to un-deployed state without first detaching the supplemental deployment rod from the T-joint.

17. The continuous asymmetric canopy umbrella apparatus of claim 14, wherein the edges of the asymmetric main canopy and the edges of the supplemental canopy incorporate an integral tensioning feature of wire or elastic cord, wherein the integral tensioning feature maintains the canopy edge shape of the asymmetric main canopy and the supplemental canopy and enhances structural rigidity.

18. The continuous asymmetric canopy umbrella apparatus of claim 14, wherein the hinge locations on the first set of main canopy ribs and second set of main canopy ribs are positioned to ensure simultaneous deployment of the asymmetric main canopy and the supplemental canopy.

19. The continuous asymmetric canopy umbrella apparatus of claim 14, wherein the asymmetric elongated canopy section incorporates an interchangeable decorative covering.

20. The continuous asymmetric canopy umbrella apparatus of claim 14, wherein the main umbrella shaft is composed of a plurality of telescoping rods and the shaft is adjustable.

21. The continuous asymmetric canopy umbrella apparatus of claim 14, wherein the main umbrella shaft includes a loop to connect a leash, thereby providing a pet a physical limitation against stepping outside a coverage area of the canopy umbrella apparatus.
